(19) United States
(12) Patent Application Publication
(10) Pub. No.: US 2008/0060633 A1
(43) Pub. Date: Mar. 13, 2008

(54) COOKING GRILL

(76) Inventor: KENNETH ANTWINE, HUNTERSVILLE, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/851,664

(22) Filed: Sep. 7, 2007

Related U.S. Application Data
(60) Provisional application No. 60/825,293, filed on Sep. 12, 2006.

(51) Int. Cl. A47J 37/00

(52) U.S. Cl. 126/25 R

(57) ABSTRACT

The present invention provides a cooking apparatus that includes a bottom portion for containing a heat source. The bottom has walls defining an upward-facing opening for supporting a food-supporting surface. A top is movable between an open position allowing access to the food-supporting surface and a closed position cooperating with the bottom to define an interior volume. The top includes an inner heat-retaining layer and an outer layer spaced-apart from the inner layer. The outer layer of the top has apertures formed therein for allowing a convection flow of heat-dissipating air between the outer and inner layers of the top to cool the outer layer.

### PRIORITY

This application is a non-provisional patent application that claims priority from provisional patent application 60/825,293 filed on Sep. 12, 2006 and entitled “COOKING GRILL.”

### TECHNICAL FIELD AND BACKGROUND OF THE INVENTION

The present invention relates to the field of cooking devices. In particular, the invention relates to a cooking grill having a heat shield.

Cooking grills are popular devices used for the preparation of food. Conventional grills include a body having a bottom portion and a top portion. The bottom portion is configured to support a cooking or grilling surface and to contain a means for providing heat such as gas burners, charcoal, wood, or the like. The top portion is often attached to the bottom portion such that it is pivotal between an open position and a closed position. The top and bottom of a grill body are generally configured to allow a draft of air through the cooking area to be controlled. In this regard, the top is often solid metal and as a result can be heavy. The body of the grill is supported by a base. Conventional grills are often placed in an outdoor setting that is accessible to both children and adults, and are used for family gatherings where people may come into contact with the grill.

One problem associated with conventional grills is that they can reach internal temperatures in excess of 500 degrees Fahrenheit, causing the grill exterior to become very hot. As a result, a child or an adult may be burned by the grill due to the high temperatures and the accessibility of the grill. Another problem associated with conventional grills is that the top portion of the body, i.e., the lid, can move from an open position to a closed position very quickly. A child or adult could be injured when the lid falls in this manner. The present invention addresses these problems.

### SUMMARY OF THE INVENTION

Therefore it is an object of the invention to provide a cooking grill that is cool to the touch.

It is another object of the invention to provide a cooking grill that has a top with a controlled motion.

These and other objects are met by the present invention, which according to one aspect provides a cooking apparatus that includes a bottom portion for containing a heat source. The bottom has walls defining an upward-facing opening for supporting a food-supporting surface. A top is movable between an open position allowing access to the food-supporting surface and a closed position cooperating with the bottom to define an interior volume. The top includes an inner heat-retaining layer and an outer layer spaced-apart from the inner layer. The outer layer of the top has apertures formed therein for allowing a convection flow of heat-dissipating air between the outer and inner layers of the top to cool the outer layer.

According to another aspect of the present invention, the bottom includes another inner heat-retaining layer and another outer layer spaced-apart from the inner layer, the outer layer having apertures formed therein for allowing a convection flow of heat-dissipating air between the outer and inner layers of the bottom to cool the outer layer.

According to another aspect of the present invention, there is provided a cooking grill that includes a body having a bottom for containing a heat source and a top for covering the bottom and defining a space for cooking. The top has a first inner layer for retaining heat and a first outer layer spaced-apart from the first inner layer. The first outer layer has apertures formed therein that are dimensioned to provide for the flow of air between in the first outer layer such that heat can be transferred from adjacent the first inner layer outside of the grill. The first outer layer is configured to be cooler than the first inner layer.

According to another aspect of the present invention, the bottom has a second inner layer and a second outer layer. The second outer layer has apertures formed therein that are dimensioned to provide for the flow of air between in the second outer layer. In this manner, heat can be transferred from adjacent the second inner layer outside of the grill, wherein the second outer layer is configured to be cooler than the second inner layer.

According to another aspect of the present invention, the top is pivotally connected to the bottom layer such that it is movable between an open first position and a closed second position.

According to another aspect of the present invention, an extensible strut has one end attached to the bottom and another end attached to the top for supporting the top in the first position and for dampening movement of the top from the open position to the closed position.

According to another aspect of the present invention, the extensible strut is positioned such that the first outer layer is between the extensible strut and the first inner layer when the top is in the closed position.

According to another aspect of the present invention, the first inner layer and the first out layer are configured such that air flows therebeteween and cools the strut when the top is in the closed position.

According to another aspect of the present invention, there is provided a cooking grill that includes a body having a bottom for containing a heat source and a top for covering the bottom and defining a space for cooking. The top has a first inner layer for retaining heat and a first outer layer spaced-apart from the first inner layer. The top is also pivotally connected to the bottom layer such that the top is movable between an open first position and a closed second position. An extendable strut has one end attached to the bottom and another end attached to the top for supporting the top in the first position and for dampening movement of the top from the open position to the closed position. The extendable strut is positioned such that the first outer layer is between the extendable strut and the first inner layer when the top is in the closed position. The first outer layer has apertures formed therein that are dimensioned to provide for the flow of air such that heat can be transferred from adjacent the first inner layer through the apertures to an area outside of the grill. The first outer layer is configured to be cooler than the first inner layer.

### BRIEF DESCRIPTION OF THE DRAWINGS

The invention may be best understood by reference to the following description in conjunction with the accompanying drawing figures in which:

FIG. 1 is a perspective view of a cooking grill with a heat shield according to an embodiment of the invention;

FIG. 2 shows the grill of FIG. 1 with a top of the cooking grill open;

FIG. 3 is a cross-sectional view of the top of the cooking grill of FIG. 1; and

FIG. 4 is a rear view of the cooking grill of FIG. 1.

### DESCRIPTION OF THE PREFERRED EMBODIMENT AND BEST MODE

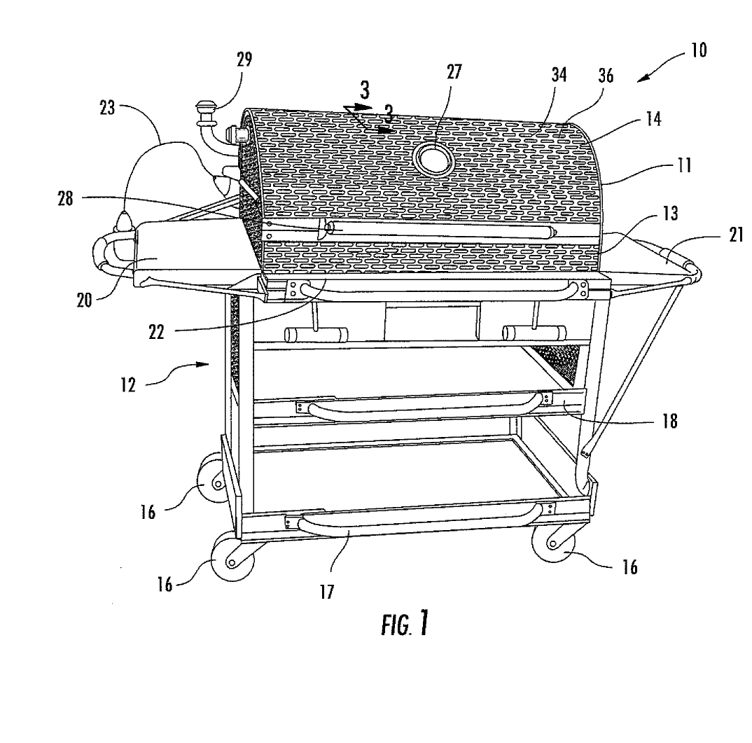

Referring now specifically to the drawings, a cooking grill according to an embodiment of the invention is illustrated in FIG. 1 and shown generally at reference numeral 10. The grill 10 includes a body 11 supported by a base 12. The base 12 is carried by wheels 16 to allow easy movement of the grill 10 and includes storage trays 17 and 18 for storing charcoal, utensils, and other items. The trays 17 and 18 are adapted to slide fore and aft in the base 12 to allow easy access to the stored items. A pair of side tables 20 and 21 extend outwardly from a top of the base 12 to provide a preparation area. A repositionable light 23 is attached to side table 20. In one embodiment, side tables 20 and 21 can be folded down when not in use. In addition, in one embodiment, at least one of the side tables includes a burner for an additional cooking surface. The base 12 also includes a front tray 22 for holding smaller items that are being used during the grilling process.

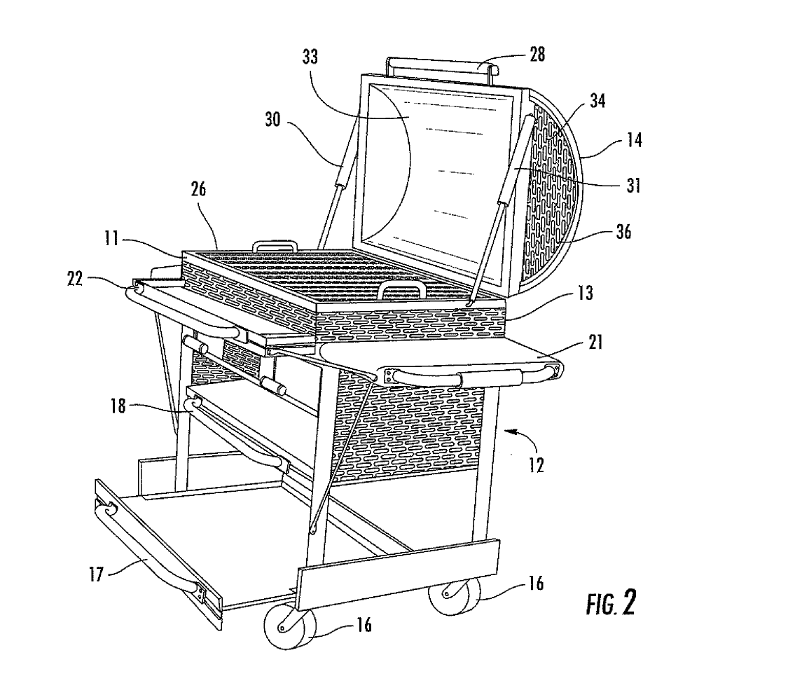

The body 11 includes a bottom 13 that is configured to house a heat source such as burners (in the case of a gas grill), charcoal (in the case of a charcoal grill), other fuel or a combination of burners, charcoal, and other fuel. The bottom 13 is also configured to support a grilling surface 26, shown in FIG. 2 at a position above the burners or charcoal. A top 14 is pivotally connected to the bottom 13 and is movable between a closed position and an open position, as shown in FIG. 1. This may be accomplished by a single hinge, a plurality of hinges, or any suitable connector that allows the top 14 to pivot with respect to the bottom 13. The top 14 includes a temperature gauge 27, a handle 28 for lifting the top 14, and an exhaust 29 for allowing smoke and other types of exhaust to escape the grill 10 during cooking.

Referring to FIG. 2, top 14 is shown in the open position. Additionally, a pair of lifts 30 and 31, such as gas spring lifts or any other suitable, extendable strut or device extends between the top 14 and the bottom 13 to control the movement of the top 14 as it is pivoted between the closed position to the open position. The lifts 30 and 31 are operable to prevent the top 14 from closing too quickly. In this manner, the lifts 30 and 31 provide safe movement of the top 14 and can prevent the top from slamming down on an individual's fingers, hand, or arm while cooking.

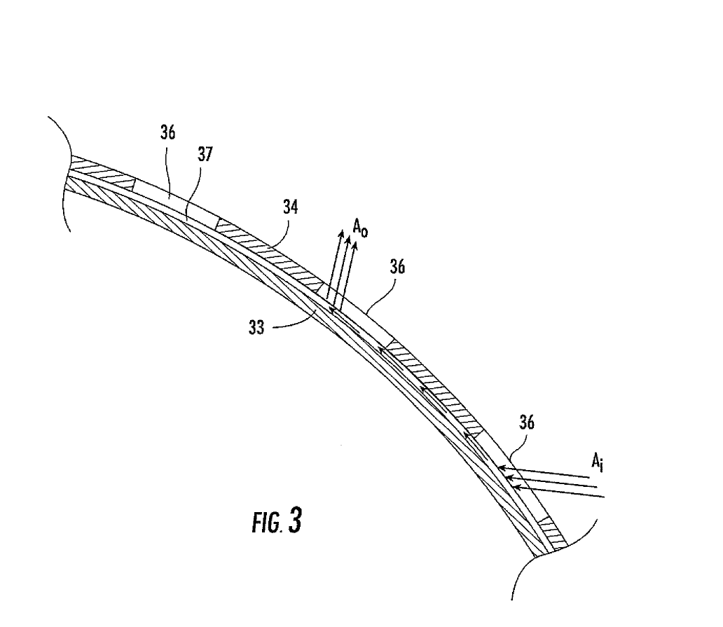

The bottom 13 and the top 14 are formed of an inner layer 33 and an outer layer 34. The inner layer 33 has vents formed therein to allow the circulation of air into the space defined by the bottom 13 and the top 14 when the top 14 is in the closed position. The vents are configured to allow the control of air into the space to provide for sufficient oxygen for combustion and airflow to aid in the removal of smoke. The inner layer 33 retains the heat being generated by the grill 10 to aid in cooking the food. The outer layer 34 provides a heat shield to protect individuals from being burned by excessive temperatures created by the grill 10. The outer layer 34 includes a plurality of apertures 36 that allow atmospheric air to flow through. As can be seen in FIG. 3, air can flow in through an aperture 36 as shown in Aᵢ along inner layer 33 and out an aperture 36 as shown at Aₒ. As shown in FIG. 3, the outer layer 34 is spaced from the inner layer 33 to form an insulation barrier 37 of atmospheric air between the inner layer 33 and outer layer 34. The outer layer 34 may be formed from sheet metal, expanded metal, wire mesh, or other similar materials.

Unlike typical insulated products that include an inner layer separated from an outer layer by a sealed insulation barrier, the apertures 36 in the outer layer 34 are dimensioned to allow atmospheric air to flow between the inner layer 33 and outer layer 34. Movement of cooler, fresh air in and hotter air out of the insulation barrier 37 reduces the amount of heat being transferred from the inner layer 33 to the outer layer 34, thereby allowing the outer layer 34 to remain at a lower temperature. In this manner, this allows the insulation barrier 37 provided by the atmospheric air to be constantly cooled by moving the hot air out of the insulation barrier 37 and replacing it with fresh cooler air. Because the outer layer 34 remains at a lower temperature, it is possible to use the lifts 30 and 31 which may contain fluids or internal components that can be damaged by high temperatures, to control the movement of the top 14.

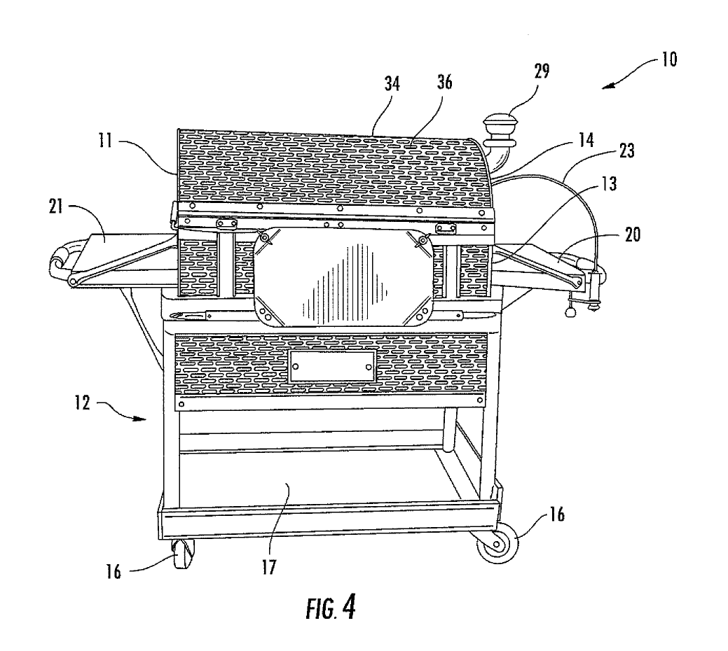

Referring to FIG. 4, a hot plate 40 is attached to a rear of the grill 10 by fasteners 41. As shown, the outer layer 34 extends around the rear of the grill 10 to prevent heat transfer to the hot plate 40. As a result, the hot plate 40 can be attached to the rear of the grill 10 for easy removal without the hazard of being burned when removing the hot plate 40. The hot plate 40 is removed by removing the fasteners 41. As illustrated, the fasteners 41 are wing nuts that are threaded onto a threaded post attached to the grill 10. However, other fasteners such as bolts and screws may be used. Once the hot plate 40 is removed, it can be placed on the grilling surface 26 to provide a solid surface for cooling food.

A cooking grill is described above. Various details of the invention may be changed without departing from its scope. Furthermore, the foregoing description of the preferred embodiments of the invention and best mode for practicing the invention are provided for the purpose of illustration only and not for the purpose of limitation.

What is claimed is:

1. A cooking apparatus, comprising:
(a) a bottom portion for containing a heat source, the bottom having walls defining an upward-facing opening for supporting a food-supporting surface;
(b) a top movable between an open position allowing access to the food-supporting surface and a closed position cooperating with the bottom to define an interior volume;
(c) the top including an inner heat-retaining layer and an outer layer spaced-apart from the inner layer, the outer layer having apertures formed therein for allowing a convection flow of heat-dissipating air between the outer and inner layers of the top to cool the outer layer.

2. A cooking apparatus as defined in claim 1, wherein the bottom includes another inner heat-retaining layer and another outer layer spaced-apart from the inner layer, the outer layer having apertures formed therein for allowing a convection flow of heat-dissipating air between the outer and inner layers of the bottom to cool the outer layer.

3. A cooking apparatus as defined in claim 1, wherein the top is pivotally connected to the bottom such that it is movable between an open first position and a closed second position.

4. A cooking apparatus as defined in claim 3, further comprising an extendable strut having one end attached to the bottom and another end attached to the top for supporting the top in the open position and for dampening movement of the top from the open position to the closed position.

5. A cooking apparatus as defined in claim 4, wherein the extendable strut is positioned such that the outer layer of the top is between the extendable strut and the inner layer of the top when the top is in the closed position.

6. A cooking apparatus as defined in claim 5, wherein the inner layer of the top and the outer layer of the top are configured such that air flows therebeteween and cools the strut when the top is in the closed position.

7. A cooking grill, comprising:
(a) a bottom for containing a heat source and defining a space for cooking;
(b) a base for supporting the bottom;
(c) a top having a first inner layer for retaining heat and a first outer layer spaced-apart from the first inner layer; and
(d) the first outer layer having apertures formed therein that are dimensioned to provide for the flow of air such that heat can be transferred from adjacent the first inner layer to an area outside of the grill, wherein the first outer layer is configured to be cooler than the first inner layer.

8. A cooking grill as defined in claim 7, wherein the bottom has a second inner layer and a second outer layer, and the second outer layer has apertures formed therein that are dimensioned to provide for the flow of air through the second outer layer such that heat can be transferred from adjacent the second inner layer to the area outside of the grill, wherein the second outer layer is configured to be cooler than the second inner layer.

9. A cooking grill as defined in claim 7, wherein the top is pivotally connected to the bottom such that the top is movable between an open first position and a closed second position.

10. A cooking grill as defined in claim 9, further comprising an extendable strut having one end attached to the base and another end attached to the top for supporting the top in the first position and for dampening movement of the top from the open position to the closed position.

11. A cooking grill as defined in claim 10, wherein the extendable strut is positioned such that the first outer layer is between the extendable strut and the first inner layer when the top is in the closed position.

12. A cooking grill as defined in claim 11, wherein the first inner layer and the first outer layer are configured such that air flows therebeteween and cools the strut when the top is in the closed position.

13. A cooking grill, comprising:
(a) a body having a bottom for containing a heat source and a top for covering the bottom and defining a space for cooking;
(b) the top having a first inner layer for retaining heat and a first outer layer spaced-apart from the first inner layer; and the top being pivotally connected to the bottom layer such that the top is movable between an open first position and a closed second position;
(c) an extendable strut having one end attached to the bottom and another end attached to the top for supporting the top in the first position and for dampening movement of the top from the open position to the closed position, wherein the extendable strut is positioned such that the first outer layer is between the extendable strut and the first inner layer when the top is in the closed position; and
(d) the first outer layer has apertures formed therein that are dimensioned to provide for the flow of air such that heat can be transferred from adjacent the first inner layer through the apertures to an area outside of the grill, wherein the first outer layer is configured to be cooler than the first inner layer.

14. A cooking grill as defined in claim 13, wherein the bottom has a second inner layer and a second outer layer; and
the second outer layer has apertures formed therein that are dimensioned to provide for the flow of air between in the second outer layer such that heat can be transferred from adjacent the second inner layer to an area outside of the grill, wherein the second outer layer is configured to be cooler than the second inner layer.

15. A cooking grill as defined in claim 13, wherein the first inner layer and the first outer layer are configured such that air can flow therebeteween and cool the strut when the top is in the closed position.
